(19) United States
(12) Patent Application Publication
(10) Pub. No.: US 2009/0205575 A1
(43) Pub. Date: Aug. 20, 2009

(54) Pet Watering Device

(76) Inventors: Florence N. Rodriguez, San Antonio, TX (US); Steven A. Gonzalez, San Antonio, TX (US)

Correspondence Address: GUNN & LEE, P.C., 700 N. ST. MARY'S STREET, SUITE 1500, SAN ANTONIO, TX, 78205, US

(21) Appl. No.: 12/034,250

(22) Filed: Feb. 20, 2008

(51) Int. Cl. A01K 7/00

(52) U.S. Cl. 119/72.5

(57) ABSTRACT

A pet watering device is shown with down spouts from an enclosed container for water. The enclosed container has a removeable top with a spring loaded door therein for refilling the container. Each down spout has a ball and seat valve at the lower end thereof which the pet can push with its tongue to get water. The enclosed container is mounted in a frame that may be adjusted vertical. One way of adjusting is with telescoping legs. Another way of adjusting is with a slot hooking over a wall mounted upward channel.

### BACKGROUND OF THE INVENTION

1. Field of The Invention

This invention relates generally to a pet watering device and, more particularly, to an adjustable mounted and enclosed pet watering device with ball and seat valves on the ends of the down spouts that may be moved by the pet to receive water.

2. Background of the Invention

In years past, pets receive their water from any means available including drinking from streams, puddles or even stagnate water. As time passed, pet owners began watering their pets in open containers such as a pet watering bowl. The pet watering bowls were normally open and could accumulate debris or pollutants in the water that could be harmful to the pets. Also, the open pet watering bowl could be easily spilled.

One attempt to solve the problem is shown in the invention entitled “Animal Water” of Ahrens, U.S. Pat. No. 4,922,858, that has a spring loaded closure valve in the top of the reservoir that contains the water. The animal has to push down on the closure valve to get to the water.

Other pet feeding or watering stands that are adjustable to accommodate pets of various heights have been designed in the past as shown in U.S. Pat. No. 4,658,759 to Brown. Telescoping legs allow the feeding tray to be adjusted vertically.

In the feeding of small animals in cages such as hamsters, it was determined that water could be put in an enclosed container and attached to the side of the cage. By extending a tube to the inside of the container in a watertight relationship, and having a ball and seat at the end of the tube, the small animal would push the ball back from its seat with the animal's tongue to receive small quantities of water. An example of such a system as shown in Atchley (U.S. Pat. No. 3,771,496) with a ball resting against a seat formed by a curved tip of a tube. Watering systems similar to Atchley has been widely used in the past for small animals such as hamsters, chinchillas, hedge hogs or similar small animals that may be maintained in cages.

Watering devices normally used for caged animals have been modified and used for larger pets such as dogs or cats as shown in U.S. Pat. No. 5,934,222 to Hwang. The pet can push the ball back with its tongue to receive water. A good representation of the ball and valve seat is shown in U.S. Pat. No. 6,553,937 to Cheng or in U.S. Pat. No. 6,588,368, also to Cheng.

It has been found that pets such as dogs or cats, after a few simple demonstrations of how to move the ball away from the seat, quickly learn how to drink water from a pet watering device having a drip tube extending downward therefrom, even if the drip tube has a ball and seat check valve in the end thereof.

On the prior pet watering devices, the refilling and washing of the reservoirs sometimes becomes a problem. At every time of refilling, it is not always necessary to wash the reservoir; however, it should be washed and cleaned periodically. Meanwhile, it should be a simple procedure to refill the reservoir while keeping the reservoir totally enclosed to keep out dirt, debris or contaminants. Some type of easy access for refilling and a total breakdown of the reservoir for washing and cleaning is desired.

### SUMMARY OF THE INVENTION

It is an object of the present invention to provide a sanitary pet watering device.

It is another object of the present invention to provide a pet watering device that is adjustable according to the height of the pet.

It is still another object of the present invention to provide and enclosed pet watering device with a down spout having a ball and seat check valve on the end thereof to allow pets to get water by moving the ball off of the seat of the check valve.

It is yet another object of the present invention to have an enclosed pet watering device with a top that is removeable for cleaning but with a smaller, normally closed, opening in the top for refilling the pet watering device.

It is another object of the present invention to have a telescopically adjustable stand for holding the pet watering device, which telescopically adjustable stand may be raised or lowered according to the height of the particular pet.

It is another object of the present invention to have a sight glass so that a pet owner can tell if the pet watering device has water without having to open the pet watering device.

It is yet another object of the present invention to provide an alternative mounting of the pet watering device by having a slot for receiving an upward channel to mount the pet watering device on a wall.

The present invention has a reservoir that is circular in design with a threaded top thereon. The threaded top has an O-ring to prevent water from leaking from the reservoir around the top. At least one down spout extends downward from the reservoir and terminates in a ball and seat check valve. A push upward on the ball contained in the down spout allows water to flow come around the ball and through the seat to a pet.

The reservoir has a sight glass on the side so that a pet owner can see if there is water inside of the reservoir. The top is threadably connected and sealed to the reservoir. In the top there is a trapped door that is normally closed that can be used in refilling the reservoir.

The reservoir is carried in a frame that is attached to telescoping legs. By extending or retracting the telescoping legs, the height of the reservoir can be changed. A pin extends through the telescoping legs to maintain the reservoir at the desired height. Alternatively, the frame can be attached to an upward channel mounted on the wall through a slot in the frame.

The top may be removed for a complete cleaning of the pet watering device. On the other hand, the pet watering device and its reservoir can be filled through the trap door in the top of the reservoir.

### BRIEF DESCRIPTION OF THE DRAWINGS

FIG. 1 is a perspective view of the pet watering device.

FIG. 2 is a top view of FIG. 1.

FIG. 3 is a front view of FIG. 2.

FIG. 4 is a side view of FIG. 3.

FIG. 5 is a sectional view of FIG. 2 along section lines 5-5 with the portion shown in broken lines being an alternate position.

FIG. 6 is a cross-sectional view of FIG. 2 along section lines 6-6.

FIG. 7 is a cross-sectional view of the reservoir.

FIG. 8A is a perspective view of an alternative mounting structure for the pet watering device.

FIG. 8 is a side view of an alternative mounting structure for the pet watering device.

### DESCRIPTION OF THE PREFERRED EMBODIMENT

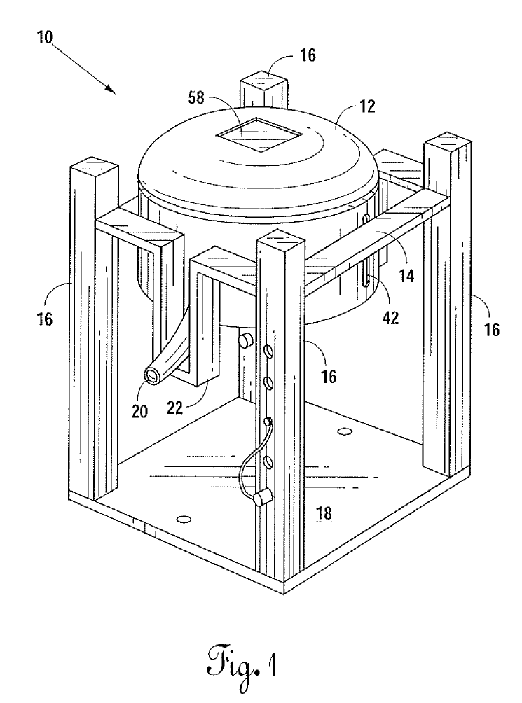

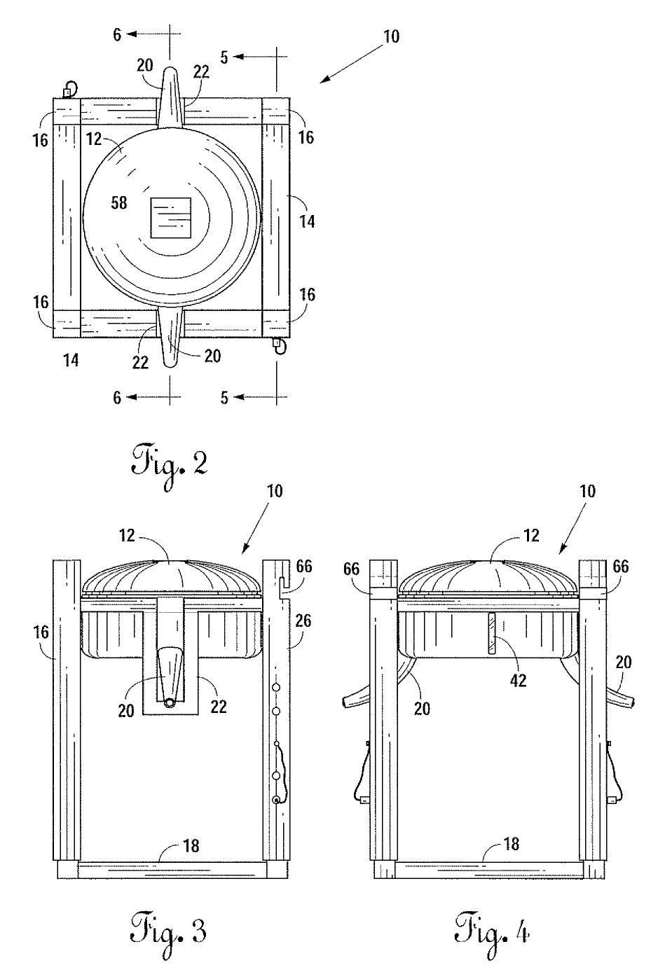

Referring to FIG. 1, a pet watering device 10 is shown in a perspective view. A reservoir 12 is carried by frame 14 attached to telescoping legs 16 mounted on base 18. The reservoir 12 has a plurality of down spouts 20 as can be clearly seen in FIGS. 2, 3 or 4. The reservoir 12 rests inside of frame 14 with down spouts 20 being located in slots 22 in the frame 14. The frame 14 extends between each of the telescoping legs 16.

Viewing FIG. 1-4 in combination, the reservoir 12 is in an abutting relationship with the inside of frame 14. The down spouts 20 rest against the bottom of the slots 22 in the frame 14 to support the reservoir 12.

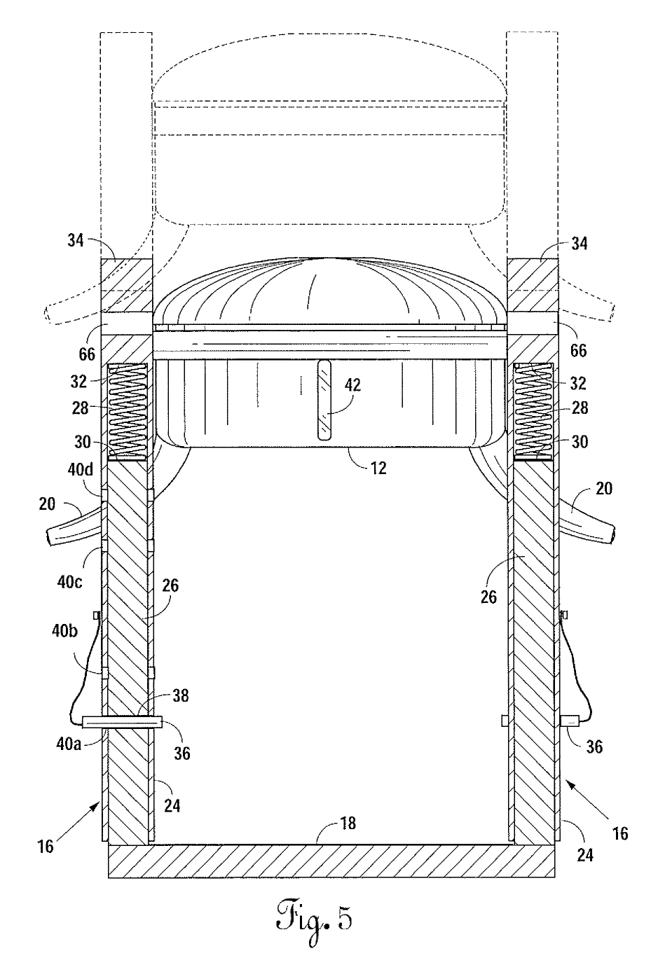

Referring now to FIGS. 2 and 5 in combination, a cross-sectional view of a pair of the telescoping legs 16 is shown. The telescoping legs have an outer shell 24 and an inner column 26. At the top of the column 26 is a spring 28 located between the top 30 of the column 26 and the underside 32 of the top portion 34 of the outer shell 24. By having the springs 28 in each of the legs 16, there is some resilience between the weight of water in the reservoir 12 and the columns 26 which are attached to the base 18.

As can be seen in FIGS. 2 and 5, the vertical position of the reservoir 12 is determined by pins 36 extending through opposing telescoping legs 16 via horizontal holes 38 in the column 26. To determine the height of the reservoir 12, the pin 36 and horizontal hole 38 is aligned with the appropriate height adjustment hole 40A, 40B, 40C or 40D. As can be seen in FIG. 5, the reservoir 12 is in its lowest position with the pin 36 extending through the lowest height adjustment hole 40A. If the reservoir 12 were adjusted its upper most position with pin 36 extending through the uppermost height adjustment hole 40D, the reservoir 12 would be in the position as represented by the broken lines. Many times a pet owner will want to know if the watering container still has water without having to open the container. As can be seen in FIG. 1, 4 and 5, the reservoir 12 has a sight glass 42 therein to look through to see if there is still water in the reservoir 12.

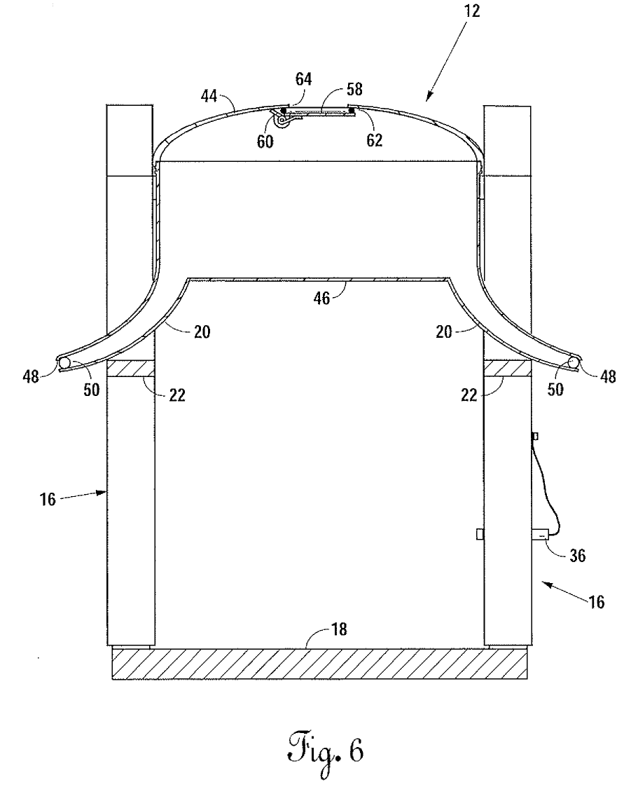

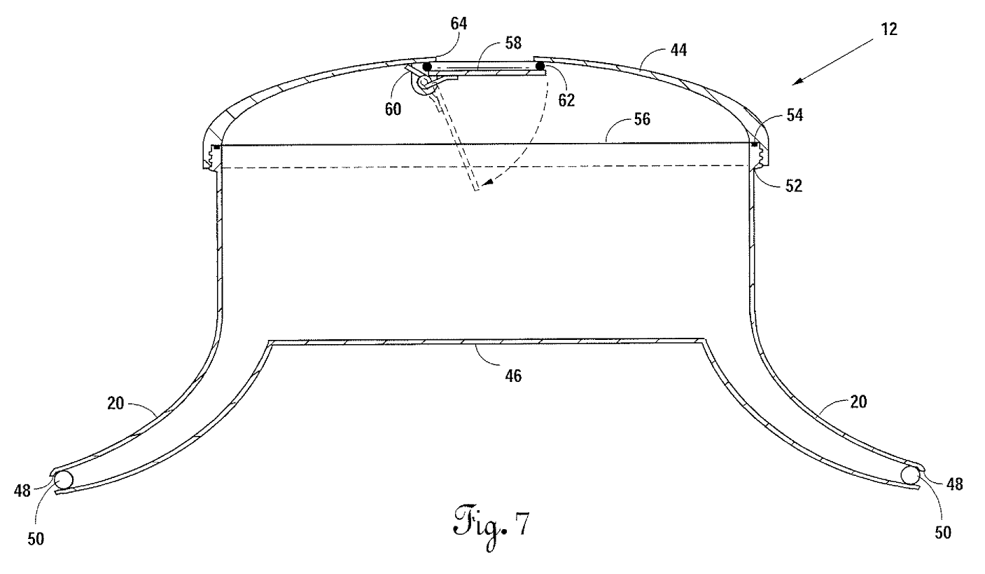

Referring to FIG. 2 and 6 in combination, a cross-sectional view of the reservoir 12 is shown. Each of the down spouts 20 of the reservoir 12 rest on the top of the slots 22 in the frame 14. The reservoir 12 has a top 44 that is threadably connected to the lower container 46 in which water for the pet may be retained. The lower tips of the down spouts 20, have an inward flare to form a seat 48 against which the ball 50 comes to rest. A pet, after being shown the trick of getting water out of the down spouts 20 will use its tongue to move the ball 50 up the down spout 20 and away from the seat 48 to receive water from the reservoir 12.

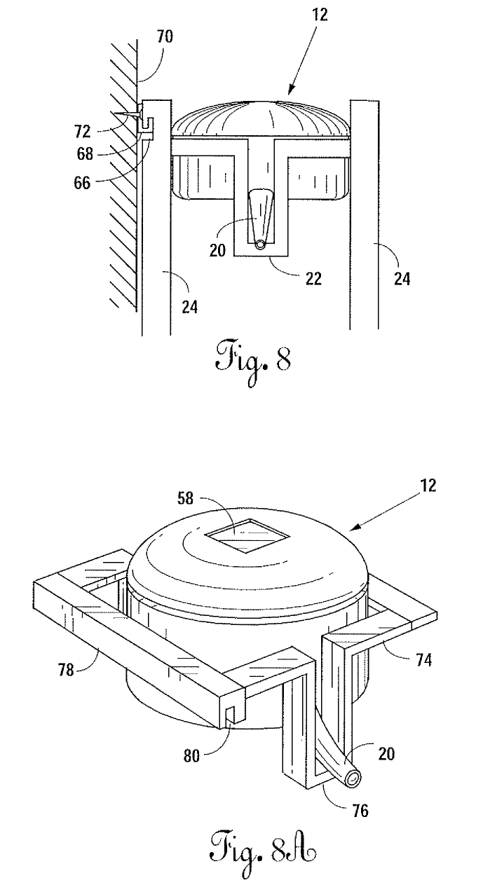

FIG. 7 is an enlarged view of the reservoir 12. The outer extremities of the top 44 has been enlarged to accommodate the threads 52 therein without breaking. An O-ring seal 54 is located in the top 56 of the lower container 46. The O-ring seal 54 prevents water from leaking between the top 44 and the lower container 46.

In the top 44 is located a spring loaded door 58 that is normally closed by the force of the spring 60 thereon. A seal 62 prevents water from leaking around spring loaded door 58 and through openings 64 in the top 44.

To refill the reservoir 12, all the pet owner has to do is to push down on spring loaded door 58 and pour water into the reservoir 12. This is fast, efficient and simple way to refill the reservoir 12. However, to clean the reservoir 12, the entire reservoir can be removed and the top 44 unscrewed. This allows access to the inside of the reservoir 12 for a more complete cleaning.

If a pet owner prefers not to have the pet watering device 10 resting on the floor but attached to the wall, the base 18 can be removed along with the columns 26 by simply removing the pins 36. By having a slot 66 into adjacent outer shells 24 of what would normally be telescoping legs 16, an alternative method of securing the reservoir 12 is provided as shown in FIG. 8. By mounting an upwardly turn channel 68 into wall 70 by any convenient means such as screws 72, the reservoir 12 may be attached to the wall as shown in FIG. 8.

If the pet owner wants to mount the reservoir 12 on the wall 70 without having the outer shell 24 of the telescoping legs 16 thereon, an alternative embodiment is shown in FIG. 8A. A different frame 74 is provided with the down spouts 20 resting on slots 76 provided in frame 74. One side of the frame 74 has a downward channel 78 with a lower slot 80 therein. Lower slot 80 can be hooked on the upwardly turn channel 68 shown in FIG. 8.

I claim:

1. A pet watering device for watering a pet comprising;
an enclosed container having a removable top for holding water therein;
at least one down spout extending downward from a lower edge of said enclosed container, said down spout having a seat at a lower end thereof;
a moveable ball normally resting against said seat to normally prevent water flow therethrough;
vertically adjustable support structure for supporting said enclosed container and allowing for said down spout to extend downward from said enclosed container; and
a spring loaded, normally closed, door in said removeable top to allow water to be added to said enclosed container;
said pet moving said moveable ball away from said seat to allow water flow from said enclosed container via said down spout to said pet.

2. The pet watering device given in claim 1 wherein said removeable top is sealed to said enclosed container.

3. The pet watering device given in claim 2 wherein said enclosed container has a sight glass therein to visually check water level in said enclosed container.

4. The pet watering device given in claim 3 wherein said vertically adjustable support structure has a frame with legs extending downward therefrom.

5. The pet watering device given in claim 4 wherein said frame has slots for said down spout and said legs are vertical adjustable in height.

6. The pet watering device given in claim 5 wherein said vertical adjustment of said legs are telescoping adjustments in said legs according to height of said pet.

7. The pet watering device given in claim 3 wherein said vertically adjustable support structure has a frame with a slot in a lower edge on one side thereof, said slot mating with an upward channel suitable for mounting on a wall.

8. The pet watering device given in claim 1 wherein there is a plurality of down spouts, each of said down spouts having said seat in the end thereof with said ball normally resting against said seat.
